(19) United States
(12) Patent Application Publication
(10) Pub. No.: US 2011/0068140 A1
(43) Pub. Date: Mar. 24, 2011

(54) RETRACTABLE CABLES IN A LOAD CARRIER

(76) Inventors: James Travis Stevens, Cheshire, CT (US); Keith Prescott, Cambridge, VT (US)

(21) Appl. No.: 12/888,127

(22) Filed: Sep. 22, 2010

Related U.S. Application Data
(60) Provisional application No. 61/244,846, filed on Sep. 22, 2009.

(51) Int. Cl. B60R 9/00

(52) U.S. Cl. 224/533

(57) ABSTRACT

A load carrier with a retracting elongate securement device, the load carrier having a support arrangement with a vehicle interfacing portion and a load support interfacing portion, as well as a load support which interfaces with the support arrangement. The load support is configured to receive and carry cargo loads thereupon and has an elongate tubular member having an extendible member received therein. The load carrier further has a biasing member operatively interposed between the elongate tubular member and the extendible member, the biasing member exerting a retracting force on the extendible member thereby urging the extendible member to a retracted configuration within the elongate tubular member.

### CROSS REFERENCE TO RELATED APPLICATIONS

This is application claims priority to provisional Application No. 61/244,846, the disclosure of which is hereby incorporated by reference in its entirety.

### TECHNICAL FIELD

The present disclosure relates to a security mechanism for load carriers attachable to vehicles for transporting various articles. In particular, the present disclosure relates to an apparatus and system for securing sporting goods and accessories to hitch-mounted racks. Further, the present disclosure relates to an extendable cable for locking a bicycle or other sport device to a hitch mounted carrier.

### BACKGROUND OF THE INVENTION

Load carriers for sporting goods and bicycle carriers are well known in the art and very popular with sports enthusiasts. Hitch mounted bicycle carriers have also become very prevalent for cyclists in transporting their bicycles to places of interest for recreation. With the increase in demand and the advancement in bicycle quality also cost and value of bicycles has correspondingly increased. Accordingly, there is a great need for protection and securing bicycles to prevent theft while transporting sporting goods and bicycles. Further, there is a need to provide security while also facilitating convenience and use of the bicycle, carriers and securement mechanisms.

### SUMMARY OF THE INVENTION

Disclosed herein is a securement device and apparatus for preventing theft of articles and sporting goods carried by load carriers, and in particular hitch mounted load carriers. The securement device and apparatus enables the locking of an article, such as a bicycle, to a load carrier thereby preventing its unauthorized removal. Furthermore, the securement device facilitates ease of use and convenience for users. One embodiment disclosed herein includes a load carrier having a retracting elongate securement device. The load carrier includes a support arrangement having a vehicle interfacing portion and a load support interfacing portion. The load carrier also includes a load support which interfaces with the support arrangement. The load support is configured to receive and carry cargo loads thereupon and has an elongate tubular member having an extendible member received therein.

The load carrier has a biasing member operatively interposed between the elongate tubular member and the extendible member, the biasing member exerting a retracting force on the extendible member thereby urging the extendible member to a retracted configuration within the elongate tubular member.

In further embodiments, the extendible member is flexible. In still further embodiments, the elongate tubular member is a metal pipe and the extendible flexible member includes a length of cable. Furthermore, the biasing member can be a coil spring. In additional embodiments, the extendible member has a fitting on the end thereof configured for insertion into a locking device.

In still further embodiments, the load carrier takes the form of hitch-mount bicycle rack and the elongate tubular member is a bicycle-receiving arm. In other embodiments, the load carrier takes the form of trunk-mount bicycle rack and the elongate tubular member is a bicycle-receiving arm. In still other embodiments, the load carrier takes the form of roof-mount cargo carrier and the elongate tubular member is a crossbar configured to extend across a carrying vehicle.

Another embodiment disclosed herein includes a rear mounted bicycle carrier having a retracting elongate securement device, said load carrier including a support arrangement having a vehicle interfacing portion and a load support interfacing portion. Also included is a load support interfaced with the support arrangement, the load support having an elongate tubular member configured to receive and carry cargo loads thereupon. An extendible cable is housed within the elongate tubular member and is configured for permitting extension of a length of the cable from said elongate tubular member. A biasing member is operatively interposed between the elongate tubular member and the extendible member, the biasing member exerting a retracting force on the extendible member thereby urging said extendible member to a retracted configuration within the elongate tubular member.

### BRIEF DESCRIPTION OF THE FIGURES

A retracting elongate securement device according to the present disclosure is described with reference to the following figures, in which:

FIG. 1 is a perspective view of one embodiment of a hitch mounted bicycle carrier rack;

FIG. 2 is a side view of one embodiment of a hitch mounted bicycle carrier rack;

FIG. 3 is an illustration of one embodiment of a lengthwise cross-sectional view of an arm of the hitch mounted bicycle carrier rack with a cable contracted;

FIG. 4 is an illustration of one embodiment of a lengthwise cross-sectional view of an arm of the hitch mounted bicycle carrier rack with the cable extended.

### DETAILED DESCRIPTION

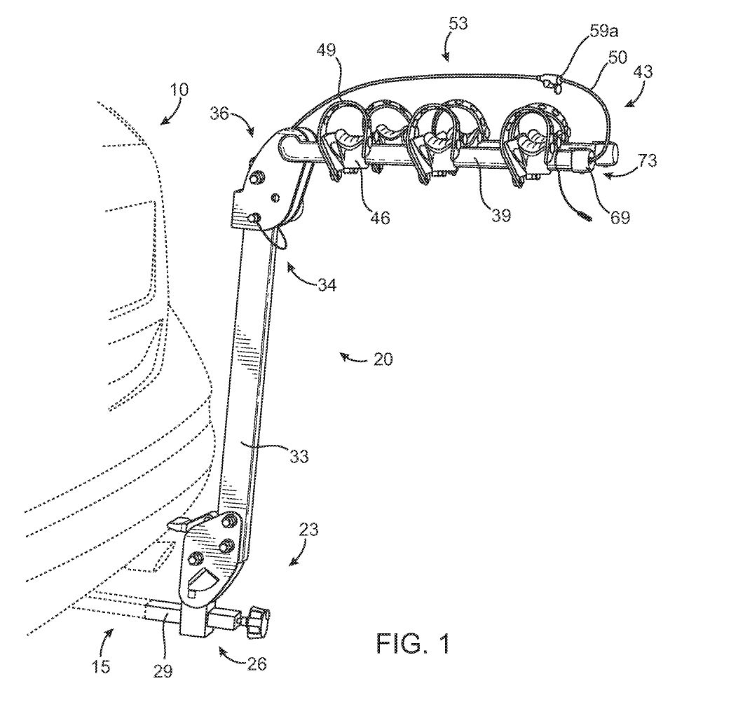

Hitch-mount bicycle racks 20 are known. A lower end 23 of the rack is provided with a stinger 29 that stabs into a hitch receiver 15 on a carrying vehicle 10 as depicted in the accompanying FIG. 1. An upstanding extension 33 is often pivotally connected to a base support 26 that includes the stinger. The capability to pivot away from the vehicle is provided to give a clearance space at the back of the vehicle, particularly to facilitate the opening of tailgates and other rear access hatches of the vehicle. An example of such a hitch-mount rack is described in U.S. Pat. No. 6,409,065, the disclosure of which is included herewith in this filing by way of a copy of the same, and which is further expressly incorporated herein by reference.

A pair of load arms 39 are provided at a top end 34 of the upstanding extension. As depicted in FIG. 1, the load arms are pivotally connected to the upstanding extension so that the arms can be moved from the transporting configuration shown in which the arms are more horizontal to a non-use configuration in which the arms are pivoted down into a more vertical orientation. The arms can exemplarily be formed from hollow tubing/pipe which is bent into a U-shape to establish the two arms extending in the same direction. As shown, the tubing is cylindrical and made of metal pipe.

Bicycle holders or cradles 46 are disposed on the arms, normally in pairs, one on each arm, and are configured to have a concave top surface that receives a bicycle frame member thereacross. As further depicted in FIG. 1, flexible straps 49 are provided on each cradle for securement around an installed bicycle frame member. While the straps are sufficient to anchor the bicycle to the rack, they are insufficient to deter unauthorized removal of bicycles from the rack.

For the security of one or more installed bicycles, an extendible cable 50 is provided. When the cable is extended as shown in FIG. 1, and with both ends secured to the rack, a securing loop 53 is formed about one or more loaded bicycles. The cable can be made up of metal, polymers, plastic, rubber, a composite, and may be solid or composed of fibers. Furthermore, if made up of a metal, a rubber outer covering can be added on the outside thereof.

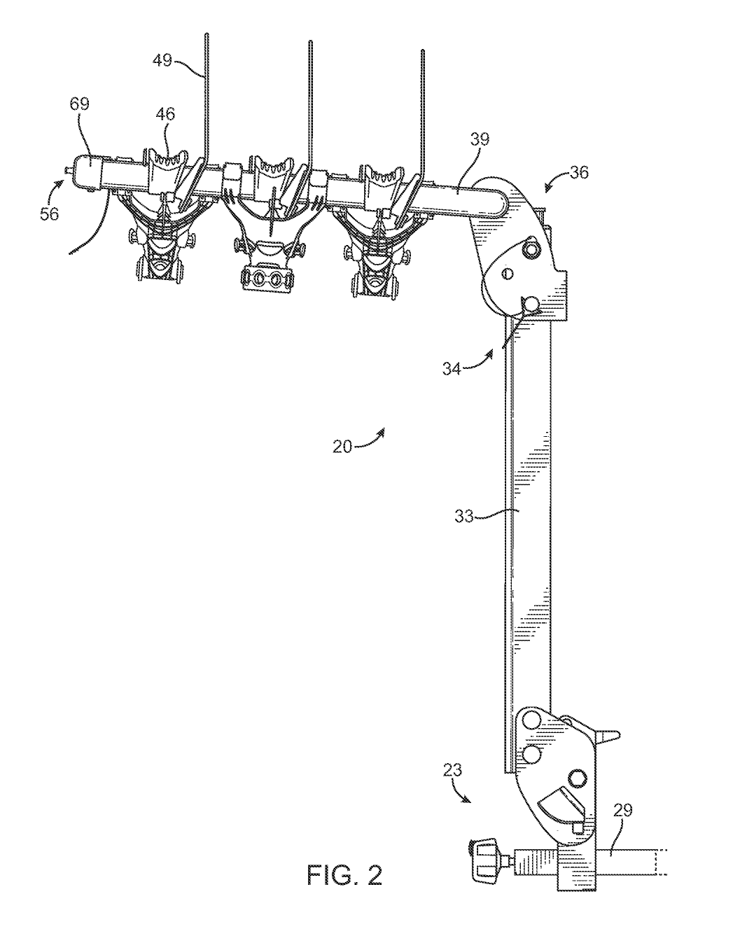

In one assemblage, the extendible cable is housed within the extension of one of the elongate arms when retracted therein as represented in FIG. 2. An extending end 56 of the cable protrudes through an aperture 73 in the distal end 43 of the arm and the opposite end of the cable that is retained within the arm has an expanded portion 63 that cannot pass through the aperture thereby anchoring the cable to the arm.

As can be appreciated for instance in FIG. 2, when the arm is substantially horizontal, the cable will remain in the retracted configuration if left in that position. However, it has been learned that when the arm tilts downward, away from horizontal, the cable can unintentionally extend out of the arm under its own weight. In order to avoid this usually undesirable extension of the cable, a biasing member 83 has been added that exerts a continuous retraction force on the cable. In addition to biasing the cable to the retracted position, it also returns the cable to the retracted position whenever a pulling force is not applied thereto. Therefore the cable can be referred to as self-retracting with the benefits that the operator does not have to sometimes awkwardly “push the rope” back into the arm, but instead just simply release the cable and it retracts under the influence of the biasing member.

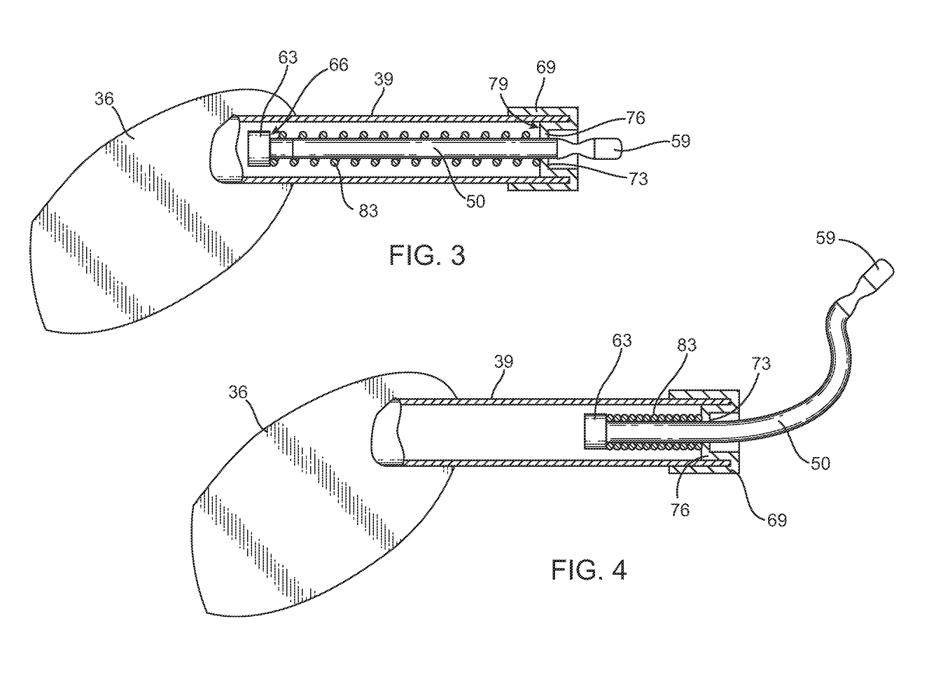

A lengthwise cross-sectional view of an arm with a cable retracted therein is shown in FIG. 3. There, a coil spring 83 is provided circumferentially about the cable. Opposite ends of the spring abut an interior surface 66 of the expansion portion of the interior end of the cable and an interior surface 79 of the wall 76 surrounding the aperture 73 through which the cable extends. As shown, the aperture and surrounding wall are formed in and on, respectively, an end cap 69 installed upon the distal open end 43 of the tubular cable-housing arm. Opposite the end cap (at the left in FIG. 3) is a hub 36 upon which the arm is supported, and the arm optionally pivots, tilts or rotates relative thereto.

FIG. 4 shows the cable 50 extended from the arm and the biasing spring 83 compressed. In this embodiment, the extended distal end 56 of the cable is provided with a fitting 59 that inserts into a locking device 59a for retention therein when the lock's clasp is closed thereupon. As can be appreciated from FIGS. 3 and 4, if no pulling force is being applied to an extended cable as in FIG. 4, the cable will be retracted back into the housing arm under the action of the spring biasing member until the configuration of FIG. 3 is achieved.

Accordingly, a user may pull out a portion of the cable 50 from the arm for use. By pulling on the cable, the force of the bias can be overcome and the cable extracted. For example, the fitting 59 can be connected with a lock such as locking device 59a. Furthermore, the cable can be easily retracted by merely letting go of the cable, as the force of the coil spring 83 draws the cable back into the carrier arm.

It should also be appreciated that elongate members other than hitch-mount carrier arms can benefit from similar cable retracting mechanisms. For instance, similar arms are included on rear-mount, or trunk-mount racks which would also benefit from a retracting cable as disclosed above. An example of such a rear-mount rack is described in United States Patent Publication No. 2007/0235487, the disclosure of which is included herewith in this filing by way of a copy of the same, and which is further expressly incorporated herein by reference.

It is also possible that such a retracting cable assembly in an elongate arm tube of a load carrier assembly would find utility in other areas of different types of load carriers, such as in a cross-bar of a roof mounted rack. An example of such a cross-bar including roof rack is described in U.S. Pat. No. 6,766,929, the disclosure of which is included herewith in this filing by way of a copy of the same, and which is further expressly incorporated herein by reference. As may be appreciated, retracting cables can advantageously be included in the cross-bars 3 for any number of purposes, including securing loads at the roof of the vehicle or pending items from the rack at sides of the carrying vehicle.

### ELEMENT LISTING

10 carrying vehicle
15 hitch receiver
20 hitch mount bicycle rack
23 lower end
26 base support
29 stinger
33 upstanding extension
34 top end
36 hub
39 load arms
43 distal end
46 cradle
49 flexible strap
50 extendible cable
53 securing loop
56 extending end
59 fitting
63 expanded portion
66 interior surface
69 end cap
73 aperture
76 wall
79 interior surface
83 biasing member (spring)

What is claimed is:

1. A load carrier having a retracting elongate securement device, said load carrier comprising:
a support arrangement having a vehicle interfacing portion and a load support interfacing portion;
a load support interfaced with said support arrangement, said load support configured to receive and carry cargo loads thereupon;
said load support comprising an elongate tubular member having an extendible member received therein;
a biasing member operatively interposed between said elongate tubular member and said extendible member, said biasing member exerting a retracting force on said extendible member thereby urging said extendible member to a retracted configuration within said elongate tubular member.

2. The load carrier as recited in claim 1, wherein said elongate tubular member is a metal pipe and the extendible flexible member comprises a length of cable.

3. The load carrier as recited in claim 2, wherein said extendible flexible member extends out a longitudinal end of the elongate tubular member.

3. The load carrier as recited in claim 1, wherein said biasing member is a coil spring.

4. The load carrier as recited in claim 1, wherein said load carrier takes the form of hitch-mount bicycle rack and said elongate tubular member is a bicycle-receiving arm.

5. The load carrier as recited in claim 1, wherein said load carrier takes the form of trunk-mount bicycle rack and said elongate tubular member is a bicycle-receiving arm.

6. The load carrier as recited in claim 1, wherein said load carrier takes the form of roof-mount cargo carrier and said elongate tubular member is a crossbar configured to extend across a carrying vehicle.

7. The load carrier of claim 1, wherein said extendible member is a cable.

8. The load carrier of claim 7, where said extendible member has a fitting on the end thereof configured for insertion into a locking device.

9. A rear mounted bicycle carrier having a retracting elongate securement device, said load carrier comprising:
a support arrangement having a vehicle interfacing portion and a load support interfacing portion;
a load support interfaced with said support arrangement, said load support having an elongate tubular member configured to receive and carry cargo loads thereupon;
an extendible cable housed within said elongate tubular member configured for permitting extension of a length of said cable from said elongate tubular member;
a biasing member operatively interposed between said elongate tubular member and said extendible member, said biasing member exerting a retracting force on said extendible member thereby urging said extendible member to a retracted configuration within said elongate tubular member.

10. The load carrier of claim 7, where said extendible member has a fitting on the end thereof configured for insertion into a locking device.

11. The load carrier as recited in claim 1, wherein said biasing member is housed within said elongate tubular member.

12. The load carrier as recited in claim 1, wherein said biasing member is a coil spring.
